(19) United States
(12) Patent Application Publication
(10) Pub. No.: US 2011/0273806 A1
(43) Pub. Date: Nov. 10, 2011

(54) METHOD FOR DETECTING A THERMAL OVERLOAD SITUATION IN A HANDHELD POWER TOOL

(76) Inventor: Heiko Roehm, Stuttgart (DE)

(21) Appl. No.: 12/812,557

(22) PCT Filed: Nov. 26, 2008
(86) PCT No.: PCT/EP2008/066193

§ 371 Date: Jul. 12, 2010

(30) Foreign Application Priority Data
Jan. 10, 2008 (DE) 102008003786.9

(51) Int. Cl. H02H 5/04

(52) U.S. Cl. 361/93.8

(57) ABSTRACT

The invention relates to a method for the detection of a thermal overload situation in a hand-held power tool, wherein the temperature or astute variable correlating to the temperature of a component is measured, wherein in case of a thermal overload a reduced transitional operation is activated, during which the current flow in the electric circuit is modulated.

The invention relates to a method for detecting a thermal overload situation in a handheld power tool, as generically defined by the preamble to claim 1.

### PRIOR ART

In German Patent Disclosure DE 10 2005 038 225 A1, a method for detecting an overload situation in a handheld power tool is described. In such handheld power tools, in particular cordless handheld power tools, such as cordless screwdrivers or cordless impact drills, there is the danger that in the event of an overload the motor will block, and in that situation, the highest possible currents that can be output by the battery pack in cordless handheld power tools are flowing. The high currents cause overheating, and at the same time because of the stopped motor, the cooling is off, so that if this situation persists, within a very brief time there is the danger of thermal failure of one or more involved components involved, such as connecting lines, the electric motor, soldered connections, or the like. There is also the danger of thermal overheating if the electric motor assumes the blocked state multiple times in succession without adequate cooldown phases.

To detect an overload situation in good time and avoid thermal failure, in DE 10 2005 038 225 A1, the operating current is continuously measured and compared with a limit current stored in memory, and a conclusion that there is a thermal overload of the handheld power tool is drawn if the difference, added up from a plurality of cycles and weighted, between the measured operating current and the current limit value stored in memory exceeds a reference value. Next, the electrical circuit that supplies the electric motor with current is interrupted by a signal from a monitoring device. The electric motor is put out of operation, and overheating is effectively avoided.

### DISCLOSURE OF THE INVENTION

It is the object of the invention to avoid a thermally caused failure of a handheld power tool, while restricting tool performance as little as possible.

This object is attained according to the invention with the characteristics of claim 1. The dependent claims recite expedient refinements.

The method according to the invention for detecting a thermal overload situation in a handheld power tool is usable particularly in cordless handheld power tools, such as cordless screwdrivers, cordless rotary drills, cordless circular saws, cordless jigsaws, cordless planes, cordless rotary hammers, or cordless impact drills. Moreover, an application to handheld power tools that are connected directly to the power grid can also be considered. The handheld power tool has an electric motor as its drive, in which there is the risk of overheating in the event of a blockage. The temperature, or a status variable of the electric motor that correlates with the temperature of a component of the handheld power tool, is measured during operation, and in the event that a reference variable is exceeded, the conclusion is drawn that a thermally elevated load exists. A reduced transition mode is thereupon activated, in which the current flow in the electrical circuit that supplies the electric motor is modulated, so that the further temperature rise is stopped or at least slowed down. As a result, even before a thermal limit, at which an overload with attendant destruction of components exists, is reached, a provision is taken that as a consequence at least damps the further temperature rise.

For the user, this has the advantage that the electric motor is not switched off but rather continues to operate to a reduced extent. Ongoing work can be continued with the handheld power tool, at least for a certain length of time; interrupting the work is not absolutely necessary.

A further advantage is that the user notices the reduced power of the electric motor and can thus take suitable measures that lead to cooling down, for instance by reducing the mechanical load or manually switching off the electric motor, but unlike the situation with an automatic switchoff, he can also do so in an orderly way.

If the electrical circuit is not manually interrupted by the user, the reduced transition mode can be continued until such time as the temperature in the handheld power tool has dropped below a predetermined limit again, and thus the state of the increased thermal load no longer exists. Thereupon, a return to the normal operating state can be made either automatically or by manual action, and in that state the electric motor produces its rated power.

The length of the transition phase can be designed variably; by way of continuous measurement of at least one status variable, which correlates with the temperature in the handheld power tool or in a component present there, the total length of the reduced transition mode can be defined. Fundamentally, however, it is also possible to design the length of the transition mode independently of measured values, for instance by defining a certain number of cycles with phases of higher and reduced current flow during the transition mode. It is thus particularly expedient in the transition mode to provide at least one phase of higher current flow, which is followed by a phase of reduced current flow. After these two phases have elapsed, a return to the normal operating state is made. Optionally, however, there can be multiple cycles with successive phases of higher and reduced current flow during the transition mode. The length of each of the phases can, as will be described hereinafter, depend on various factors, among others the temperature.

For defining the current pulse length and the current pulse level as well as for the phase of higher current flow and the phase of reduced current flow, a number of criteria can be employed. Advantageously, in the transition mode there is first a phase of higher current flow, which is followed by a phase of reduced current flow. The current pulse level during the phase of higher current flow can be set to constant value, such as the level of the operating current, the value of the switchover current that prevails directly at the instant of switchover from regular operation to the transition mode, or to some other current value, which may also be lower than the regular operating current. A dependency of the current pulse level, during the phase of higher current flow, on the length of the phase of reduced current flow is also possible. In that case, with a long phase length during the reduced phase, a higher current can be selected during the phase of increased current flow.

For defining the current pulse length during the phase of higher current flow, various criteria may be employed. Advantageously, the current pulse length is determined as a function of the switchover current that flows before the switchover to the transition mode. For instance, the current pulse length varies inversely to the switchover current, so that when there is a high switchover current, a shorter pulse phase is established than when there is a lower switchover current, as a result of which a count is taken of the greater heating of the electrical components by the higher switchover current. In addition, an exponential dependency on the switchover current can be selected; the device-specific exponent of the exponential function advantageously has values between 1 and 3 and can be selected for instance to be greater, the greater the thermal load on the handheld power tool. Since the current pulse length is in inverse proportion to the current value, a higher exponent results in a correspondingly shorter current pulse length, so that the phase of higher current flow during the transition mode lasts a correspondingly shorter length of time.

The current pulse level and current pulse length during the phase of reduced current flow that follows the phase of higher current flow can also be set on the basis of various criteria. Analogously to the current pulse length in the phase of increased current flow, a dependency of the current pulse length during the phase of reduced current flow on the value of the switchover current at the instant of the change from regular operation to the transition mode is also selected. It has proved expedient in this respect, with an increasing switchover current, also to establish a longer current pulse length during the phase of reduced current flow, so that the temperature, rising with increasing current during regular operation, is compensated for by a longer period of repose during the transition mode. The current pulse level during the phase of reduced current flow is expediently limited to a value which is below the limit current that is used as a threshold value for the transition from regular operation to the transition mode. The current pulse level here is either at a value greater than zero, so that the electric motor of the handheld power tool can continue to be operated at markedly reduced power, or, in a further version, at zero, which is equivalent to shutting off the electric motor during the reduced phase. In both cases, that is, both with reduced current flow and with completely switched-off current flow, the temperature in the handheld power tool can drop until it falls below the limit temperature.

The length of the current pulses both during the phase of higher current flow and during the phase of reduced current flow can furthermore be adjusted as a function of temperature. Expediently, the temperature gradient that prevails just before the switchover to the transition mode is used for this. To that end, two successive temperatures, for instance, can be determined, and the difference in the temperature values before the onset of the transition mode is determinative for the current pulse length for the phase of higher current flow and/or the phase of reduced current flow. It is expedient that when the temperature gradient is rising and relatively great, the current pulse length during the phase of higher current flow is set to be less, while the current pulse length during the reduced current flow is set to be greater. The rising temperature gradient results in increasing heating, which taken into account of by way of a suitable adjustment of the current pulse length during the phases of increased and reduced current flow.

In principle, it suffices to measure the actual operating current, as the status variable correlating with the temperature of a component, and to compare it with a limit current stored in memory and to conclude whether there is a thermal overload from the difference. This is a predictive procedure, since corrective provisions, particularly at the switchover to the transition mode, can already be made even before a critical temperature value is reached.

Advantageously, the temperature of at least one temperature-critical component in the handheld power tool is measured continuously, including during the transition mode. If despite the reduced current flow in the transition mode, the temperature-critical component exceeds a critical temperature, then the transition mode is discontinued by cutting the current flow.

Typically, the transition mode is ended when either the defined phases of increased and reduced current flow have taken place, or, in an alternative embodiment, when in the event of continuous successive phases of increased and reduced current flow, a interruption criterion is met, in particular if the temperature drops below a limit current.

Further advantages and expedient embodiments can be learned from the further claims, the description of the drawings, and the drawings.

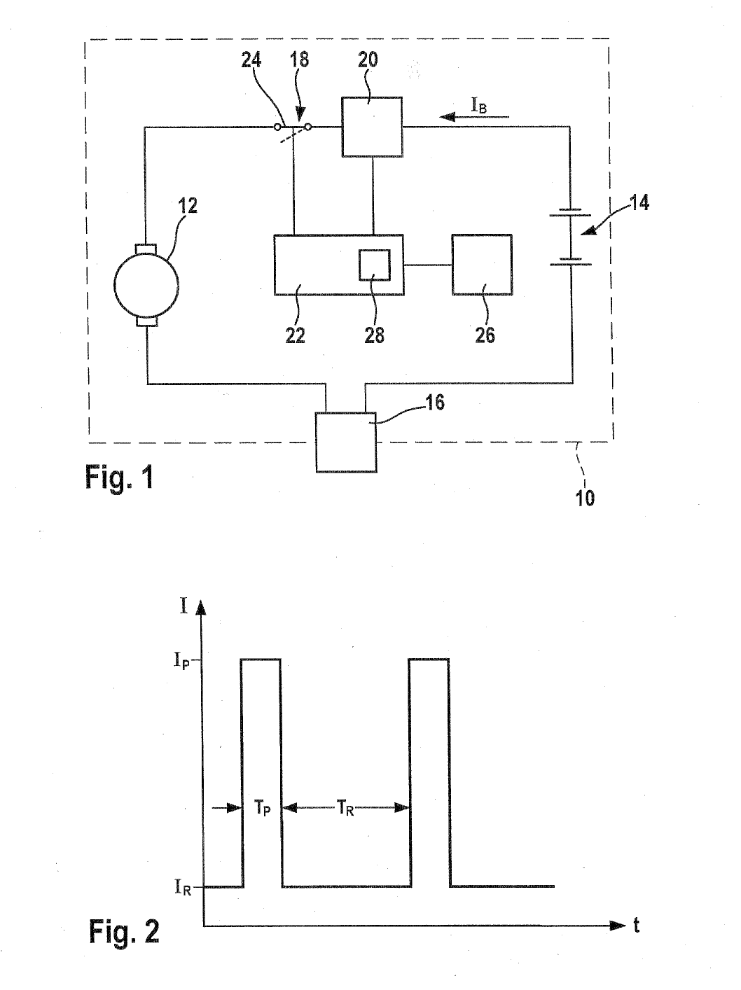

FIG. 1 shows a symbolically represented exemplary embodiment of a handheld power tool, with a monitoring device for detecting a thermal overload situation and for switching to a transition mode of reduced electrical power;

FIG. 2 is a graph showing the current flow as a function of time during the transition mode.

The handheld power tool 10 shown in FIG. 1 has its drive an electric motor 12, which is supplied with energy by a battery pack 14. In the electrical circuit between the battery pack 14 and the electric motor 12 is a user control element 16, with which the user can open and close the electrical circuit. An interrupter 18, which includes a switch 24, and a current measuring device 20 are also disposed in the electrical circuit. When the electrical circuit is closed, an operating current I_{B} flows.

The interrupter 18 is triggered by a monitoring device 22, with which the current measuring device 20 and a temperature measuring device 26 for measuring the temperature of at least one temperature-critical component in the handheld power tool 10 are associated. The monitoring device 22 also includes a regulating or control unit 28, in which the signal processing and generation takes place and in which constants are also stored in memory. During typical operation of the handheld power tool 10, the electrical circuit is closed; the electric motor 12 is supplied with the operating current I_{B}. In regular operation, the actual operating current I_{B} is continuously measured via the current measuring device 20; via the temperature measuring device 26, which is embodied for instance as an NTC resistance measuring unit, the temperature of the at least one temperature-critical component in the handheld power tool is also measured. The measured actual operating current I_{B} is compared with a limit current I_{G} stored in memory, and from the difference, in accordance with the equation

I_{D}=I_{B}−I_{G}

A differential current I_{D} is formed. The current measurements are done at high clock speed; for instance, 244 current measurements per second can be made. The current measurement furthermore has the advantage that the temperature being established can be ascertained without a time lag. This is done in a predictive manner, by concluding that a thermal overload of the handheld power tool is present from the difference I_{D} between the operating current I_{B} and the limit current I_{G}, and this is done even before the temperature reaches a critical value.

If the measured operating current I_{B} is above the limit current I_{G} stored in memory, the latter being below the maximum allowable continuous current, then the differential current I_{D} enters into a summation formula,

Σ(I_{D})ⁿ≦z(T₀)·ₘ

The individual values of the differential current I_{D} are exponentiated with an exponent n, which has values between 1 and 3, depending on the particular tool. The exponentiated differential currents are added up, and regular operation of the handheld power tool is maintained as long as the aforementioned inequality is met. The added-up values of the exponentiated differential current are compared with a system- and temperature-dependent factor z(T₀), which is multiplied by a factor m that indicates the measured values per second, or in other words for instance 244 measurements per second. T₀ indicates the outset temperature, such as 20°.

The factor z(T₀) can be calculated from the equation

z(T₀)=zₛ·z_{T}(T₀)

in which zₛ designates a system-dependent factor, and z_{T}(T₀) designates a temperature compensation, which in accordance with

0≦z_{T}(T₀)≦1

assumes values between 0 and 1. If upon activation the allowable maximum temperature has already been reached, z_{T}(T₀) is 0. The value for z_{T}(T₀) is 1, if upon activation a temperature level prevails at which zₛ was defined, which involves a system-dependent, constant factor.

The switchover instant for the switchover from regular operation to the transition mode is reached when the summation condition is no longer met, or in other words the added-up exponent values of the differential current I_{D} are greater than the product of the system- and temperature-dependent factor z(T₀) and the number of measurements m. In that case, a switchover is made to the transition mode, in which the electric motor continues to be operated at only reduced power, and accordingly the further temperature rise is also at least slowed down, but expediently is reversed.

The transition mode is characterized by a phase of higher current flow and an ensuing phase of reduced current flow; even in the phase of higher current flow, expediently only a current that is less than the limit current I_{G} flows. A plurality of cycles, each with one phase of higher and one phase of lower current flow can succeed one another during the transition mode. The number of cycles is either defined in advance, or else cycles with current pulses of higher and lesser current flow repeat continuously until an interruption criterion such as the drop below a limit temperature, is reached.

FIG. 2 is a current-time graph I(t), which shows the idealized current course during the transition mode. Individual rectangular current pulses with a current pulse level I_{P}, which characterize the phases of higher current flow, can be seen; the current pulse level I_{P} can assume the value of the regular operating current, but can optionally also be below that. In each case, however, the value Iₚ is limited to a maximum value.

The phase of higher current flow having the current pulses I_{P} is followed by a phase of lower current flow, with a current pulse level I_{R}, and I_{R} also assumes a value greater than zero but is considerably below I_{P}. Optionally, I_{R} is set to zero.

The current pulse length T_{P} during the phase of higher current flow is ascertained in accordance with the equation

$${T}_{P} ( {I}_{\ddot{U}} ) = \frac{k}{{( {I}_{\ddot{U}} - {I}_{G} )}^{n}}$$

In this equation, k indicates a system-dependent parameter, I_{Ü} indicates the switchover current that prevails just before the switchover to the transition mode, I_{G} indicates the limit current, which is stored in memory as a fixed value, and n indicates the system-dependent exponent with values between 1 and 3.

The current pulse length T_{R} during the phase of reduced current flow is ascertained as a function of the switchover current I_{Ü} and of the limit current I_{Ü}x in accordance with the equation

T_{R}(I_{Ü})=f·(I_{Ü}−I_{G})ⁿ

in which f indicates a system-dependent factor.

The current pulse length during the phase of higher current flow and the current pulse length T_{R} during the phase of reduced current flow can be adjusted as a function of temperature. For that purpose, the temperature gradient ΔT just before the switchover to the transition mode is determined by subtracting two successive temperature values T_{Ü} and T_{Ü-1} from one another in accordance with ΔT=T_{Ü}T_{Ü-1}; T_{Ü} indicates the temperature at the switchover instant and T_{Ü-1} indicates the temperature at the measurement instant just before it. The temperature gradient ΔT has an influence on the system-dependent factors k and f for calculating the current pulse length T_{P} and T_{R}, respectively, during the phases of higher and lower current flow in the transition mode. At a temperature gradient ΔT that is both relatively great and rising, the current pulse length T_{P} during the phase of higher current flow is set to be less, and during the phase of reduced current flow is set to be greater, in that the system-dependent factor k for calculating the pulse length T_{P} is chosen to be less, and the system-dependent factor f for calculating the pulse length T_{R} is chose to be greater.

Both the current measurement and the temperature measurement are done continuously, both in regular operation and in the transition mode. If during the transition mode the temperature of the at least one temperature-critical component exceeds a limit temperature, then the transition mode is interrupted by cutting the current flow. Conversely, if the temperature drops below a threshold value, a return can be made to the regular mode of operation.

1-22. (canceled)

23. A method for detecting a thermal overload situation in a handheld power tool, in particular a cordless handheld power tool, which as its drive has an electric motor, and the temperature, or a status variable of the electric motor that collates with the temperature of a component of the handheld power tool, is measured and if a reference variable is exceeded, a conclusion is drawn that there is a thermally elevated load, wherein in the event of a thermally elevated load, a reduced transition mode is activated, in which the current flow and the electrical circuit is modulated.

24. The method as defined by claim 23, wherein an actual operating current is measured and compared with a limit current stored in memory, and from a difference between the operating current and the limit current, a conclusion is drawn that there is a tub of the handheld power tool.

25. The method as defined by claim 23, wherein in the transition mode, at least one phase of higher current flow and one phase of reduced current flow succeed one another.

26. The method as defined by claim 25, wherein that a current pulse length during the phase of higher current flow is determined as a function of a switchover current before a switchover to the transition mode.

27. The method as defined by claim 26, wherein the current pulse length is set to be lower at a higher switchover current and higher at a lower switchover current.

28. The method as defined by claim 26, wherein the current pulse length is ascertained in accordance with the equation
$${T}_{P} ( {I}_{\ddot{U}} ) = \frac{k}{{( {I}_{\ddot{U}} - {I}_{G} )}^{n}}$$
in which
k stands for a system-dependent parameter
I_{Ü} stands for the switchover current before the switchover to the transition mode
I_{G} stands for the limit current
n stands for an exponent.

29. The method as defined by claim 28, wherein the exponent has a value of between one and three.

30. The method as defined by claim 23, wherein a current pulse level is limited to the value of the switchover current.

31. The method as defined by claim 23, wherein a current pulse level during the phase of higher current flow is specified as a constant value.

32. The method as defined by claim 23, wherein a current pulse level during a phase of higher current flow is determined as a function of the low-current or current-free phase length.

33. The method as defined by claim 23, wherein the current pulse length during a phase of reduced current flow is specified as a constant value.

34. The method as defined by claim 23, wherein a current pulse length during the phase of reduced current flow is determined as a function of a switchover current.

35. The method as defined by claim 34, wherein the current pulse length is determined as a function of the switchover current and of the limit current in accordance with the equation
T_{R}(I_{Ü})=f·(I_{Ü}−I_{G})ⁿ
in which
f stands for a system-dependent factor.

36. The method as defined by claim 23, wherein a current pulse level during a phase of reduced current flow is below the limit current.

37. The method as defined by claim 23, wherein a current pulse level during a phase of reduced current flow amounts to zero.

38. The method as defined by claim 23, wherein a current pulse length during a phase of higher current flow and/or the current pulse length during a phase of reduced current flow is set as a function of temperature.

39. The method as defined by claim 38, wherein a temperature gradient is determined before a switchover to the transition mode and is used for calculating the current pulse length.

40. The method as defined by claim 39, wherein with an increasing temperature gradient, the current pulse length during the phase of higher current flow is set lower, and the current pulse length during the phase of reduced current flow is set higher.

41. The method as defined by claim 23, wherein as a status variable, an operating current of the electric motor is measured, and if a reference variable is exceeded, a reduced transition mode is activated.

42. The method as defined by claim 23, wherein a temperature of at least one temperature-critical component is measured, and if a limit temperature is exceeded, the transition mode is discontinued by cutting the current flow.

43. A monitoring device for performing the method as defined by claim 23.

44. A handheld power tool having a monitoring device as defined by claim 43.
